(19) United States
(12) Patent Application Publication
(10) Pub. No.: US 2022/0212549 A1
(43) Pub. Date: Jul. 7, 2022

(54) MODULAR RANGE EXTENDER SYSTEM FOR AN ELECTRICALLY DRIVEN MOTOR VEHICLE, AND ELECTRICALLY DRIVEN MOTOR VEHICLE HAVING A RANGE EXTENDER

(71) Applicant: EGO REX GMBH, Aachen (DE)

(72) Inventors: Stefan DANY, Aachen (DE); Jan-Philipp PROTE, Aachen (DE); Waldemar SCHNEIDER, Esslingen (DE)

(73) Assignee: EGO REX GMBH, Aachen (DE)

(21) Appl. No.: 17/603,530

(22) PCT Filed: Apr. 16, 2020
(86) PCT No.: PCT/EP2020/060718

§ 371 Date: Oct. 13, 2021

(30) Foreign Application Priority Data
Apr. 18, 2019 (DE) 10 2019 110 317.7

(51) Int. Cl. B60L 50/71; B60L 50/72; H01M 8/04082; H01M 8/04089; H01M 8/249; H01M 8/2465; H01M 16/00

(52) U.S. Cl. CPC B60L 50/71; B60L 50/72; H01M 8/04201; H01M 8/04089; H01M 2220/20; H01M 8/2465; H01M 16/006; H01M 2250/20; H01M 8/249

(57) ABSTRACT

The invention relates to a modular range extender system (20) for an electrically driven motor vehicle (52), comprising a plurality of fuel cell basic modules (10), which each have a plurality of fuel cells connected in series and interfaces for supplying hydrogen and air as well as for discharging water and residual gas; a media supply device, which is designed to supply air and hydrogen to the fuel cell basic modules (10) via the interfaces and to discharge water and residual gas from the fuel cell basic modules (10) via the interfaces, wherein, in order to provide different outputs and/or voltages, different numbers of the fuel cell basic modules (10) are electrically connectable to one another in different series and/or parallel circuits and are configurable with the media supply device to form different variants of the range extender (22). The invention also relates to a circuit arrangement (40) for a vehicle electrical system of an electrically driven motor vehicle (52) and to an electrically driven motor vehicle having a circuit arrangement (40) of this kind.

The present invention relates to a modular range extender system for an electrically driven motor vehicle, a circuit arrangement for a vehicle electrical system of an electrically driven motor vehicle with a predetermined variant of a range extender of the modular range extender system as well as an electrically driven motor vehicle with a circuit arrangement of this kind.

Electrically driven motor vehicles often still have a relatively limited range due to the current energy density of high-voltage batteries. In order to extend the range, it is known per se to use so-called range extenders in electric vehicles, in order to increase the range. The currently most frequently used range extenders have internal combustion engines, which drive a generator, which in turn supplies the high-voltage battery and/or the electrical drive machine electric motor with power.

In addition, range extenders are also known, which have a multiplicity of fuel cells. An advantage of said range extenders is that they are virtually emission-free, since hydrogen and oxygen usually react to form water. Normally, such range extenders based on fuel cells require one or more compressors, in order to supply the compressed air to the fuel cells. The compressors have to be adapted to the respective range extender in a relatively complex manner. In addition, the electrical interconnection of such range extenders based on fuel cells with a high-voltage battery is relatively expensive.

The object addressed by the present invention is therefore to provide a solution, by means of which range extenders based on fuel cells can be adapted particularly easily to different boundary conditions.

Said object is solved by the subjects of the independent claims. Further possible embodiments of the invention are indicated in the dependent claims.

The modular range extender system according to the invention for an electrically driven motor vehicle comprises a plurality of fuel cell basic modules, which each have a plurality of fuel cells connected in series and interfaces for supplying hydrogen and air as well as for discharging water and residual gas. Furthermore, the modular range extender system comprises a media supply device, which is designed to supply air and hydrogen to the fuel cell basic modules via the interfaces and to discharge water and residual gas from the fuel cell basic modules via the interfaces. In order to provide different outputs and/or voltages, different numbers of fuel cell basic modules are electrically connectable to one another in different series and/or parallel circuits and are configurable with the media supply device to form respective variants of a range extender.

It is essential in the modular range extender system that the individual fuel cell basic modules can be scaled by a corresponding combination as desired for each application case to form an overall system, therefore, a specific variant of a range extender. By means of a corresponding parallel circuit and series circuit of the individual fuel cell basic modules, different variants of a range extender can be configured, which differ, for example, with regard to the power that can be provided, but, for example, can provide the same high voltage. Of course, it is also possible that the fuel cell basic modules can be interconnected in such a way that the voltages that can be provided differ in the case of different variants of the range extender.

The fuel cell basic modules can also include a wide variety of peripheral and system components that are integrated into the respective fuel cell basic modules for a highly independent function of said fuel cell basic modules. In particular, it is possible, in a configuration correspondingly adapted to a respective boundary condition to achieve a particularly high service life and efficiency in the relevant variant of the range extender. This is possible, among other things, in that a design adapted to the boundary condition can be achieved with defined operating points of the relevant variant of the range extender. In particular, it is also possible to design the respective variants of the range extender for a partial load range.

In particular, it is possible by means of the modular range extender system according to the invention, to configure variants of a range extender adapted to respective boundary conditions on the basis of the fuel cell basic modules that can be produced relatively inexpensively. Thus, it is possible to configure and to build different variants of range extenders based on the fuel cell basic modules, which can differ virtually as desired in terms of their output and voltage level.

The individual fuel cell basic modules can, for example, have a reactive surface of approx. 100 cm² and approx. 80 fuel cells. Of course, it is also possible, to design the number and surface of the bipolar plates and the number of fuel cells differently. The fuel cells connected in series for each fuel cell basic module can, for example, provide an open circuit voltage of 80 V and a voltage of 48 V in full load operation. However, depending on the design of the fuel cell basic modules other open circuit voltages and other operating points are also possible.

By means of the modular range extender system it is possible, for example, to configure very different variants of a range extender based on fuel cells for very different vehicle types. Thus, for example, a particularly powerful variant of a range extender can be provided for an electrically driven utility vehicle, and it is also possible, for example, to configure a less powerful variant of a range extender for an electrically driven small car based on the same fuel cell basic modules. The individual fuel cell basic modules have to be developed, tested and released only once. Subsequently, said different variants of the range extender can be configured on the basis of the preferably standardised fuel cell basic modules.

In particular, on the basis of the modular range extender system it is possible to configure a range extender on a fuel cell basis for a specific electric vehicle, which can be connected in parallel to a high-voltage battery of the electric vehicle without interposition of a DC voltage converter. The usually rather expensive DC voltage converter can therefore be dispensed with. Indeed, the voltage level of the correspondingly configured range extender on the basis of the modular range extender system can be adapted very easily to the voltage level of the relevant high-voltage battery, simply by connecting the individual fuel cell basic modules appropriately to one another in series and parallel circuits.

A possible embodiment of the invention provides that the fuel cell basic modules all have the same structure with regard to their components. In particular, it is also possible that the fuel cell basic modules all have the same dimensions. The fuel cell basic modules can thus be produced in large quantities in a particularly cost-effective manner, since they all consist of the same preferably standardised components.

A further possible embodiment of the invention provides that the fuel cell basic modules have their own control, wherein said control can be run on a common hardware of a respective variant of the range extender. In particular, this should be understood to mean that a software of the control does not necessarily have to run on a hardware associated with the respective fuel cell basic module, but rather can also run as software, for example, as a subroutine within a main control, on a control unit of the range extender. This has the advantage that one is not restricted to each fuel cell basic module having to maintain the corresponding control hardware. Said own control can therefore be understood as software. The fuel cell basic modules can thus be very easily exchanged with one another, for example, in the event of a fault with replacement modules, therefore with other fuel cell basic modules that have not been installed up to now. For this purpose, the control, sensor system and/or software for controlling a fuel cell basic mode—or else a software of the higher-level overall system, therefore of the relevant range extender variant—do not have to be changed or adapted.

A further possible embodiment of the invention provides that the fuel cell basic modules are designed to provide in each case an output in the range of 2 to 8 kW. Depending on the properties of the membrane electrode units installed in the fuel cell basic modules, the output can be different for the same reactive surface of the fuel cell basic modules. The aim is for all fuel cell basic modules to provide at least substantially exactly the same output. As a result, the scaling or configuration of different variants of the range extender on the basis of the individual fuel cell basic modules is particularly simple, since they provide at least substantially the same output. Preferably, the fuel cell basic modules also all have the same voltage.

According to a further possible embodiment of the invention it is provided that the media supply device for each fuel cell basic module has a separate air compressor for providing air. In particular, if the fuel cell basic modules are all designed the same or all have the same structure, exactly the same air compressor can also be used for all fuel cell basic modules. Regardless of this, it is possible in particular to provide exactly the right air compressor suitable for the respective fuel cell basic modules, which air compressor is adapted to the conditions of the respective fuel cell basic module. An air compression system for a certain variant of the range extender can also be configured and assembled particularly easily with regard to the air compressor. Indeed, for a certain variant, just as many air compressors have to be provided as there are fuel cell basic modules that have to be interconnected. A respective complex and new design of an air compression device for different variants of range extenders can therefore be dispensed with.

A further possible embodiment of the invention provides that the media supply device has a central media supply channel for supplying air and hydrogen as well as for discharging water, residual gas and air for the fuel cell basic modules, wherein the fuel cell basic modules can be coupled to the media supply channel to the left and right of said media supply channel. In addition to air, the residual gas contains unused or unreacted hydrogen. By means of this standardised structure, the fuel cell basic modules can be easily connected to the media supply channel in the case of very different configurations of the fuel cell basic modules. The media supply channel has standardised interfaces for this purpose, which can interact with likewise standardised interfaces of the respective fuel cell basic modules. Thus, it is possible very easily to couple the respective fuel cell basic modules to the media supply channel to the left and right of said media supply channel. The modular range extender system can, for example, have one or also a plurality of variants of different housings, wherein the central media supply channel can be integrated into these housings. Depending on the configured variants of the relevant range extender, the suitable housing variant with the associated media supply can then be selected. The individual fuel cell basic modules then simply only have to be connected to the relevant media supply channel.

According to a further possible embodiment of the invention, it is provided that the basic modules in each case have a first end plate and a second end plate, which are arranged at opposite ends of the fuel cell basic modules and between which the respective fuel cells are arranged, wherein exclusively the first end plate has the interfaces for supplying air and hydrogen as well as for discharging water, residual gas and air. This makes possible a particularly compact design for the relevant variant of the configured range extender. In addition, all interfaces on the respective fuel cell basic modules can be kept relatively small, since these are exclusively integrated into the first end plate.

A further possible embodiment of the invention provides that within the fuel cell basic modules, the fuel cells are positioned in two cell stacks arranged next to one another and electrically connected in series with one another, which cell stacks have a common U-shaped media guide for air, hydrogen, water and residual gas, wherein the second end plate for each basic module has a directional diversion for the media guide from one to the other cell stack. By means of the two cell stacks arranged next to one another and the U-shaped media guide, a particularly compact and flat design is produced for the individual fuel cell basic modules. This compact and in particular short design promises a relatively good robustness against mechanical loads and in particular against vibrations. The short and compact design also enables a simpler manufacture, since the smaller the number of stacked fuel cells and thus the shorter the design, the less the effect of tolerances. In addition, a highly automated production of the fuel cell basic modules can also be realised.

The circuit arrangement according to the invention for a vehicle electrical system of an electrically driven motor vehicle comprises a predetermined variant of a range extender based on the modular range extender system according to the invention or a possible embodiment of the modular range extender system according to the invention, a high-voltage battery for supplying energy to an electric drive machine of the motor vehicle, wherein the high-voltage battery and the range extender are interconnected without a DC voltage converter in the form of a parallel circuit and the range extender is designed to charge the high-voltage battery. In addition, the circuit arrangement comprises a switching device for establishing and disconnecting an electrically conductive connection between the range extender and the high-voltage battery. The circuit arrangement according to the invention has the particular advantage that it is possible to dispense with a normally otherwise required DC voltage converter, which is a relatively expensive component. The variant of the range extender is thereby designed in such a way that, on the one hand, it can charge the high-voltage battery without any problems and, on the other hand, it can be operated in such a way that it is not damaged when the range extender is connected or switched on, in particular, respective membranes of the range extender are not damaged. Said switching device can, for example, be a MOSFET, a transistor or also a mechanical relay, wherein freewheeling diodes can also be provided as safety elements.

The electrically driven motor vehicle according to the invention comprises the circuit arrangement according to the invention or a possible embodiment of the circuit arrangement.

A possible embodiment of the electrically driven motor vehicle provides that respective air compressors of the range extender for providing air to the fuel cell basic modules are arranged at other points in the motor vehicle than the associated fuel cell basic modules. Thus, although the air compressors can therefore be assigned to the respective fuel cell basic modules, they do not have to be arranged locally directly on the fuel cell basic modules. This can have a very advantageous effect with regard to the existing installation space or the utilisation of the existing installation space. The respective air compressors can be arranged individually or also combined in groups at suitable points in the electrically driven motor vehicle, specifically precisely where the air compressors have enough space and can suck in ambient air as well as possible. The fuel cell basic modules can in turn be arranged, for example, combined at a particularly crash-favourable point in the motor vehicle, where they also have a positive effect, for example, on a low centre of gravity of motor vehicle.

Further possible advantages, features and embodiments of the invention are described by means of the following figures. The features and combinations of features mentioned above in the description and the features and combinations of features shown alone below in the figure description and/or in the figures can be used not only in the combination indicated in each case, but also in other combinations or alone, without leaving the scope of the invention.

The drawing shows in:

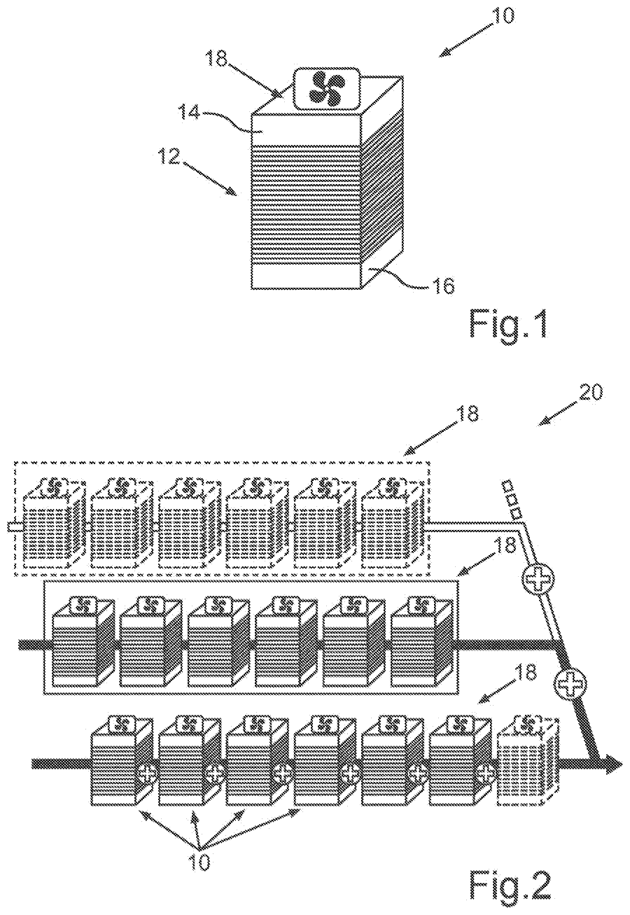

FIG. 1 a schematic perspective view of a fuel cell basic module, which has a plurality of fuel cells connected in series and to which a compressor for supplying air is assigned;

FIG. 2 a schematic representation of a plurality of fuel cell basic modules, which combined groups are connected in series, wherein some of said groups are in turn connected to one another in parallel;

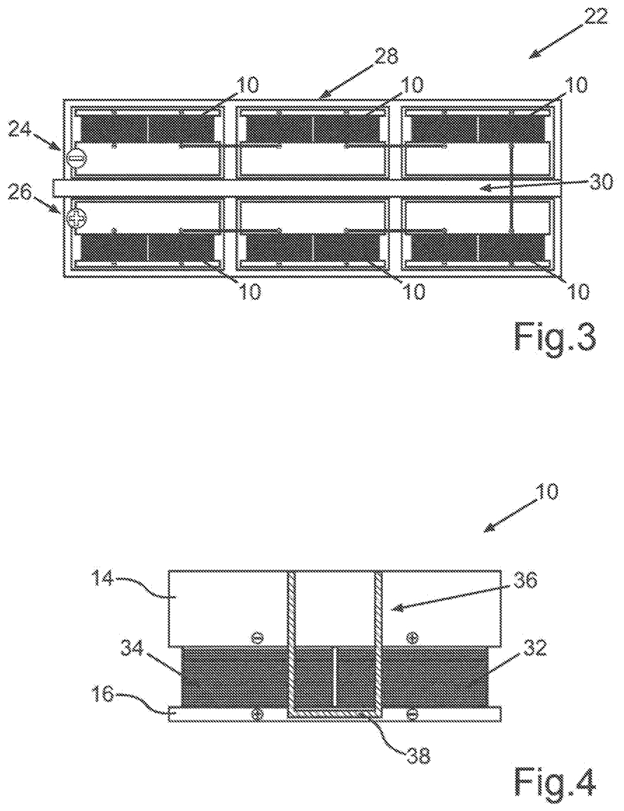

FIG. 3 a schematic top view of a possible variant of a range extender, which has been configured on the basis of the individual fuel cell basic modules;

FIG. 4 a top view of one of the fuel cell basic modules, wherein a U-shaped media guide is depicted schematically;

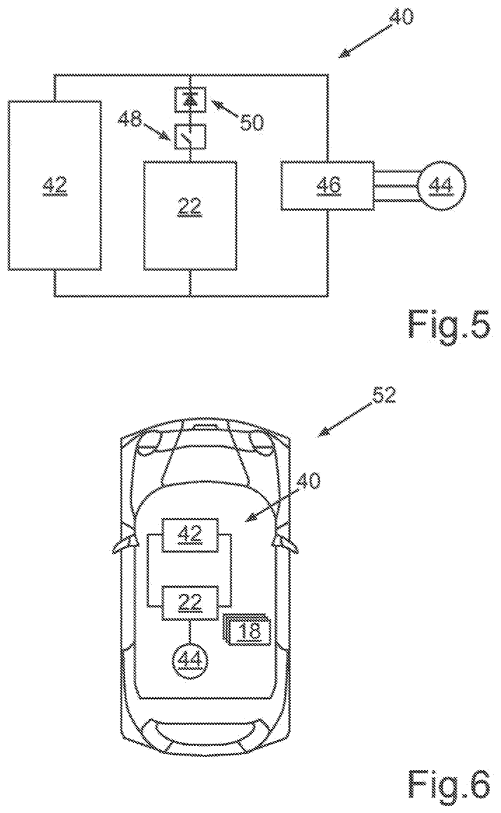

FIG. 5 a highly schematised representation of a circuit arrangement for a vehicle electrical system of an electrically driven motor vehicle, which comprises a parallel circuit of a variant of a range extender and a high-voltage battery; and in

FIG. 6 a schematic representation of an electrically driven motor vehicle, which has a variant of the range extender composed of the fuel cell basic modules.

In the figures, identical or functionally identical elements have been provided with the same reference signs.

In FIG. 1, a fuel cell basic module 10 is depicted in a perspective view in a highly schematised manner. The fuel cell basic module 10 comprises a stack 12, also called a stack, of a plurality of fuel cells connected in series and not described in further detail. The fuel cells comprise respective bipolar plates and respective so-called membrane electrode units. The fuel cell basic module 10 additionally comprises a first end plate 14 and a second end plate 16, between which the stack 12 is arranged.

In addition, the fuel cell basic module 10 comprises a plurality of interfaces not shown here for supplying hydrogen and air as well as for discharging water and residual gas. It can thereby be provided that exclusively the first plate 14 forms a kind of plug-and-play front end, which has all interfaces. In addition, a compressor 18 is associated with the fuel cell basic module 10, which is used to convey air and thus oxygen to the individual fuel cells. Contrary to the present representation, however, it is not required that the compressor 18 is arranged directly on the fuel cell basic module 10. Instead, it can also be provided that the compressor 18 is arranged at a completely different point during installation in the relevant motor vehicle than the fuel cell basic module 10. It must merely be ensured by means of a corresponding line or piping, that the compressor 18 can convey air and thus oxygen to the fuel cell basic module 10.

In FIG. 2, a plurality of the fuel cell basic modules 10 are depicted. In order to provide different outputs and/or voltages, different numbers of fuel cell basic modules 10 can be electrically connected to one another in different series and/or parallel circuits and can be configured with a media supply device not shown here to form respective variants of a range extender. Said media supply device, not shown here, is designed to supply air and hydrogen via the mentioned interfaces of the respective fuel cell basic modules 10 and to discharge water and residual gas from the respective fuel cell basic modules 10 via the interfaces.

In the present case, several groups 19 of fuel cell basic modules 10 connected to one another in series are shown schematically. For example, so many of the fuel cell basic modules 10 are connected to one another in series for each group 19, that these can provide a voltage of, for example, 480 V and an output of 24 kW. Another interconnection is of course also possible. By connecting the individual groups 19 in parallel, it is possible to increase the output that can be provided, while the voltage remains the same. In principle, any scaling of the output for each application case is possible by a corresponding interconnection of the individual fuel cell basic modules 10.

The individual fuel cell basic modules 10 can have, for example, a reactive surface of approx. 100 cm² and 80 individual fuel cells. Other surfaces and numbers are also possible. Thus, for example, it is possible that the respective fuel cell basic modules 10 can provide an open circuit voltage of 80 V and a voltage of 48 V under full load, wherein the fuel cell basic modules 10 can be designed, for example, to provide an output in the range of 2 to 8 kW. Other voltages and outputs are also possible, in particular, depending on the selected or installed membrane electrode units in the individual fuel cell basic modules 10.

In particular, it can be provided that the fuel cell basic modules 10 all have the same structure with regard to their components. The fuel cell basic modules 10 therefore form highly standardised units, in which the same components are installed everywhere. This enables high economies of scale to be achieved with correspondingly low purchasing and production costs. The individual fuel cell basic modules 10 as well as the media supply device mentioned therefore jointly form a modular range extender system 20, wherein depending on the boundary condition or application case the standardised fuel cell basic modules 10 can be interconnected in a wide variety of configurations. In each case the fuel cell basic modules can have their own control, wherein said control can be run, for example, on a common hardware for a specific configured variant of a range extender.

In FIG. 3, a possible variant of a range extender 22 is shown in a highly schematised manner in a top view, which has been configured or assembled on the basis of the individual fuel cell basic modules 10. Purely by way of example, the individual fuel cell basic modules 10 have all been connected to one another in series. A negative pole 24 and a positive pole 26 of the thus configured range extender 22 are indicated schematically. The respective fuel cell basic modules 10 are arranged in an enclosure 28. The previously mentioned media supply device comprises a central media supply channel 30 for supplying air and hydrogen as well as for discharging water, residual gas and air for the respective fuel cell basic modules 10. As can be seen, the individual fuel cell basic modules 10 are arranged to the left and right of the media supply channel 30 and coupled to the latter. For this purpose, the media supply channel 30 comprises interfaces not shown in detail, which can interact with the interfaces of the individual fuel cell basic modules 10 already mentioned above.

In FIG. 4, one of the fuel cell basic modules 10 installed in the range extender 22 is schematically depicted in a top view. Deviating from the embodiments shown in FIGS. 1 and 2, the fuel cells, not described in greater detail here, are positioned within this fuel cell basic module 10 in two cell stacks 32, 34 arranged next to one another and electrically connected in series. The fuel cell basic module 10 comprises an only schematically indicated U-shaped media guide 36 for air, hydrogen, water and residual gas, wherein the second end plate 16 has a directional diversion 38 for the media guide from one to the other cell stack 34, 32. The first end plate 1 in turn has exclusively the interfaces, not depicted in detail here, for supplying air and hydrogen as well as for discharging water and residual gas.

This results in a particularly compact design of the fuel cell basic modules 10. In particular, a particularly flat design and short design can thus be achieved for the range extender 22 configured on the basis of the thus designed fuel cell basic modules 10.

In FIG. 5, a circuit arrangement 40 for a vehicle electrical system, not shown in more detail, of an electrically driven motor vehicle is depicted in a highly schematised manner. The circuit arrangement 40 comprises a predetermined variant of a range extender 22 based on said modular range extender system 20. Furthermore, the circuit arrangement 40 comprises a high-voltage battery 42 for supplying energy to an electric drive machine 44 of the relevant motor vehicle. A frequency converter 46, which is associated with the electric drive machine 44, is also shown schematically. The high-voltage battery 42 and the range extender 22 are interconnected in the form of a parallel circuit without a DC voltage converter, wherein the range extender 22 is designed to charge the high-voltage battery 42.

A circuit arrangement 48 for establishing and disconnecting an electrically conductive connection between the range extender 22 and the high-voltage battery 42 is also part of the circuit arrangement 40. The switching device 48 can, for example, be a MOSFET, a transistor or also a mechanical relay. One or a plurality of freewheeling diodes 50 can also be provided as safety elements. Due to the fact that the circuit arrangement 40 does not have a DC voltage converter, installation space and corresponding costs can be saved. It can be ensured by a correspondingly suitable predictive regulation or control, that when the range extender 22 is switched on, it is nevertheless not damaged.

In FIG. 6, an electrically driven motor vehicle 52 is depicted in a highly schematised manner. A part of the circuit arrangement 40 is also shown schematically. Several of the previously mentioned air compressors 18 are also shown schematically. The air compressors 18 are assigned to the individual fuel cell basic modules 10 (not shown) of the relevant or configured variant of the range extender 22. The air compressor 18 can convey sucked-in air to the individual fuel cell basic modules 10 via corresponding channels or lines. The air compressors 18 do not thereby—as already mentioned—have to be arranged directly on the fuel cell basic modules 10. Instead, the air compressors 18 can be arranged at other suitable points in the motor vehicle 52, in particular where the space conditions allow it particularly well and at the same time the ambient air can be sucked in particularly well by means of the air compressor 18.

The individual fuel cell basic modules 10 can in turn be arranged with regard to a favourable vehicle centre of gravity and a favourable packaging at other points in the motor vehicle 52. The individual air compressors 18 can be combined, for example, in the form of a compressor module. Depending on the configuration of the range extender 22 and above all depending on the number of fuel cell basic modules 10 installed therein, the number of air compressors 18 to be used can vary. The number of air compressors 18 thereby corresponds precisely to the number of fuel cell basic modules 10.

### LIST OF REFERENCE SIGNS

10 fuel cell basic module
12 stack of fuel cells connected in series
14 first end plate
16 second end plate
18 air compressor
19 groups of fuel cell basic modules connected in series
20 modular range extender system
22 variant of a range extender
24 negative pole of the range extender
26 positive pole of the range extender
28 enclosure of the range extender
30 central media supply channel
32 cell stack
34 cell stack
36 U-shaped media guide
38 directional diversion for the media guide
40 circuit arrangement
42 high-voltage battery
44 electrical drive machine
46 frequency converter
48 switching device
50 free-wheeling diode
52 motor vehicle

We claim:

1. A modular range extender system (20) for an electrically driven motor vehicle (52), comprising
a plurality of fuel cell basic modules (10), which each have a plurality of fuel cells connected in series and interfaces for supplying hydrogen and air as well as for discharging water and residual gas;
a media supply device, which is designed to supply air and hydrogen to the fuel cell basic modules (10) via the interfaces and to discharge water and residual gas from the fuel cell basic modules (10) via the interfaces;
wherein, in order to provide different outputs, different numbers of fuel cell basic modules (10) are electrically connectable to one another in different parallel circuits and/or in order to provide different voltages, different numbers of fuel cell basic modules (10) are electrically connectable to one another in different series circuits and are configurable with the media supply device to form respective variants of a range extender (22).

2. The modular range extender system (20) according to claim 1,
wherein
the fuel cell basic modules (10) all have the same structure with regard to their components.

3. The modular range extender system (20) according to claim 1,
wherein
the fuel cell basic modules (10) have their own control, wherein said control can be run on a common hardware of a respective variant of the range extender (22).

4. The modular range extender system (20) according to claim 1,
wherein
the fuel cell basic modules (10) are designed to provide an output in each case in the range of 2 to 8 kW.

5. The modular range extender system (20) according to claim 1, wherein
the media supply device for each fuel cell basic module (10) has a separate air compressor (18) for providing air.

6. The modular range extender system (20) according to claim 1, wherein
the media supply device has a central media supply channel (30) for supplying air and hydrogen as well as for discharging water and residual gas for the fuel cell basic modules (10), wherein the fuel cell basic modules (10) can be coupled to the media supply channel to the left and right of the media supply channel (30).

7. The modular range extender system (20) according to claim 1, wherein
the fuel cell basic modules (10) each have a first end plate (14) and a second end plate (16), which are arranged at opposite ends of the fuel cell basic modules (10) and between which the respective fuel cells are arranged, wherein exclusively the first end plate (14) has the interfaces for supplying air and hydrogen as well as for discharging water.

8. The modular range extender system (20) according to claim 7,
wherein
within the fuel cell basic modules (10) the fuel cells are positioned in two cell stacks (32, 34) arranged next to one another and electrically connected to each other in series, which have a common U-shaped media guide (36) for air, hydrogen, water and residual gas, wherein the second end plate (16) for each basic module has a directional diversion (38) for the media guide (36) from one to the other cell stack (32, 34).

9. A circuit arrangement (40) for a vehicle electrical system of an electrically driven motor vehicle (52), comprising
a predetermined variant of a range extender (22) based on a modular range extender system (20) according to any one of the preceding claims;
a high-voltage battery (42) for supplying energy to an electrical drive machine (44) of the motor vehicle (52);
wherein the high-voltage battery (42) and the range extender (22) are interconnected without a DC voltage converter in the form of a parallel circuit and the range extender (22) is designed to charge the high-voltage battery (42)
a switching device (48) for establishing and disconnecting an electrically conductive connection between the range extender (22) and the high-voltage battery (42).

10. An electrically driven motor vehicle (2), comprising a circuit arrangement (40) according to claim 9.

11. The electrically driven motor vehicle (52) according to claim 10,
wherein
respective air compressors (18) of the range extender (22) for providing air for the fuel cell basic modules (10) are arranged at other points in the motor vehicle (52) than the associated fuel cell basic modules (10).
